(19) United States
(12) Patent Application Publication
(10) Pub. No.: US 2008/0189120 A1
(43) Pub. Date: Aug. 7, 2008

(54) METHOD AND APPARATUS FOR PARAMETRIC ENCODING AND PARAMETRIC DECODING

(75) Inventors: Jae-one OH, Yongin-si (KR); Geon-hyoung LEE, Hwanseong-si (KR); Chul-woo LEE, Suwon-si (KR); Jong-hoon JEONG, Suwon-si (KR); Nam-suk LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/021,760

(22) Filed: Jan. 29, 2008

(30) Foreign Application Priority Data
Feb. 1, 2007 (KR) 10-2007-0010675

(51) Int. Cl. G10L 19/00

(52) U.S. Cl. 704/501; 704/E19.019

(57) ABSTRACT

A method of and apparatus for parametric encoding and parametric decoding are provided. According to the method and apparatus, not all parameters for all component signals are generated and according to a time interval, parameters for some component signals are replaced by index information allowing similar previous time intervals to be found, thereby increasing encoding efficiency.

### CROSS-REFERENCE TO RELATED PATENT APPLICATIONS

This application claims priority from Korean Patent Application No. 10-2007-0010675, filed on Feb. 1, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding and decoding an audio signal, and more particularly, to parametric encoding and decoding.

2. Description of the Related Art

Most related art high quality audio encoding apparatuses use a time-frequency transform method. According to this method, the coefficients obtained by transforming an input audio signal into the frequency domain by using transformation methods, such as a modified discrete cosine transform (MDCT), are encoded. In this case, however, when the target bit rate is lowered, the expressed sound quality is also reduced.

In the related art, a parametric encoding method has been used for encoding an audio signal at a low bitrate. Examples of the parametric encoding method include a harmonic and individual lines plus noise (HINL) method and a sinusoidal coding (SSC) method. According to the parametric encoding method, an original audio signal is modeled using component signals having predetermined characteristics. The component signals are detected from the audio signal, and parameters indicating the characteristics of the detected component signals are encoded. For example, if an audio signal is formed of a plurality of sinusoidal waves, the sinusoidal waves are detected from the audio signal, and only the frequency, phase, and amplitude of each of the detected sinusoidal waves are encoded, thereby achieving encoding an audio signal at a low bitrate.

FIG. 1 is a simplified block diagram of a related art parametric encoding apparatus. The parametric encoding apparatus illustrated in FIG. 1 operates on the assumption that an audio signal is formed of transient signals, sinusoidal signals, and noise. If a pulse code modulation (PCM) signal of the audio signal is input, a transient signal analyzer 110 analyzes transient signals included in the PCM signal, generates transient signal parameters, and a quantization unit 120 quantizes and encodes the transient signal parameters.

A transient signal synthesizer 130 synthesizes transient signals again from the transient signal parameters, and a signal obtained by subtracting the synthesized transient signals from the original PCM signal is input to a sinusoidal analyzer 140.

The sinusoidal analyzer 140 analyzes sinusoidal signals included in the input signal, generates sinusoidal parameters, and a quantization unit 150 quantizes and encodes the sinusoidal parameters.

A sinusoidal synthesizer 160 synthesizes sinusoidal signals again from the sinusoidal parameters, and a signal obtained by subtracting the sinusoidal signals synthesized in the sinusoidal synthesizer 160 from the input signal is input to a noise analyzer 170. The noise analyzer 170 generates noise parameters from the input signal, and a quantization unit 180 quantizes and encodes the noise parameters.

A multiplexer 190 multiplexes the data of the encoded parameters and outputs the result as a bitstream.

In this way, in the related art parametric encoding apparatus, all component signals included in an audio signal are encoded as parameters in an analyzer for each component signal. However, when a plurality of time intervals having similar component signals exist, this method is inefficient because identical data should be redundantly encoded.

### SUMMARY OF THE INVENTION

The present invention provides a parametric encoding and decoding apparatus and method by which already encoded parameters of previous time intervals are used to encode time intervals not yet encoded, and already decoded parameters of previous time intervals are used to decode time intervals not yet decoded.

According to an aspect of the present invention, there is provided a parametric encoding method including: detecting a second transient signal similar to a first transient signal from among transient signals occurring before the first transient signal; detecting a second time interval in which a component signal similar to a component signal of a first time interval after the occurrence of the first transient signal exists, from among time intervals after the occurrence of the second transient signal; and encoding the component signal of the first time interval by using information on the second time interval.

The information on the second time interval may include at least one of information indicating the position of the second time interval, information indicating a frequency band in which the similar component signal exists, from among the frequency bands of the second time interval, and information indicating the type of the similar component signal.

The information indicating the position of the second time interval may include information indicating an index distinguishing the transient signal occurring at the start of the second time interval from other transient signals, and information indicating a position relative to the transient signal.

In the encoding of the component signal of the first time interval, the information on the second time interval may be used as a parameter for the component signal in the first time interval.

The detecting of the second transient signal may be performed by comparing the energies of the transient signals occurring before the first transient signal with the energy of the first transient signal.

In the detecting of the second transient signal, transient signals similar to the first transient signal may be detected in each frequency band, and in the detecting of the time interval, a time interval(s) may be detected in the frequency band(s) in which transient signals similar to the first transient signal are detected, and in the encoding of the component signal, the component signal in the first time interval may be encoded in each frequency band by using the information on the detected time interval(s).

The component signal may include one of a sinusoidal signal and noise.

According to still another aspect of the present invention, there is provided a computer readable recording medium having embodied thereon a computer program for executing the methods.

According to another aspect of the present invention, there is provided a parametric encoding apparatus including: a transient signal detection unit detecting a second transient signal similar to a first transient signal among transient signals occurring before the first transient signal; a time interval detection unit detecting a second time interval in which a component signal similar to a component signal of a first time interval after the occurrence of the first transient signal exists, from among time intervals after the occurrence of the second transient signal; and an encoding unit encoding the component signal of the first time interval by using information on the second time interval.

According to another aspect of the present invention, there is provided a parametric decoding method including: determining whether or not a parameter indicating a component signal of a time interval desired to be decoded is prediction information that has a format indicating a time interval(s); and restoring the component signal of the time interval desired to be decoded, by selectively using the parameter in relation to a time interval(s) before the time interval desired to be decoded, according to the determination result.

If the determination result indicates that the parameter indicating the component signal of the time interval to be decoded is the prediction information, the restoring of the component signal may include: by referring to the prediction information, determining the position of the previous time interval, a frequency band in which the parameter exists among the frequency bands of the previous time interval, and type of the component signal to be decoded based on the parameter; decoding the parameter for the component signal of the determined type in the determined frequency band in the determined previous time interval; and regarding the signal obtained by the decoding as the component signal of the determined type in the determined frequency band in the time interval to be decoded, and generating a whole output signal in the time interval to be decoded.

According to still another aspect of the present invention, there is provided a computer readable recording medium having embodied thereon a computer program for executing the methods.

According to another aspect of the present invention, there is provided a parametric decoding apparatus including: a determination unit determining whether or not a parameter for a component signal of a time interval desired to be decoded is prediction information that has a format indicating a time interval(s); and a restoration unit restoring the component signal of the time interval desired to be decoded, by selectively using the parameter for previous time interval(s), according to the determination result.

### BRIEF DESCRIPTION OF THE DRAWINGS

The above and other features of the present invention will become more apparent by describing in detail exemplary embodiments thereof with reference to the attached drawings in which:

FIG. 1 is a simplified block diagram of a related art parametric encoding apparatus;

FIG. 2 is a graph showing waveforms of an audio signal to be encoded according to an exemplary embodiment of the present invention;

FIG. 3 is a flowchart illustrating a method of encoding an audio signal according to an exemplary embodiment of the present invention;

FIG. 4 is a diagram illustrating a structure of an apparatus for encoding an audio signal according to an exemplary embodiment of the present invention;

FIG. 5 is a diagram illustrating a structure of prediction information used in a method of encoding and decoding an audio signal according to an exemplary embodiment of the present invention;

FIG. 6 is a flowchart illustrating a method of decoding an audio signal according to an exemplary embodiment of the present invention; and

FIG. 7 is a diagram illustrating a structure of an apparatus for decoding an audio signal according to an exemplary embodiment of the present invention.

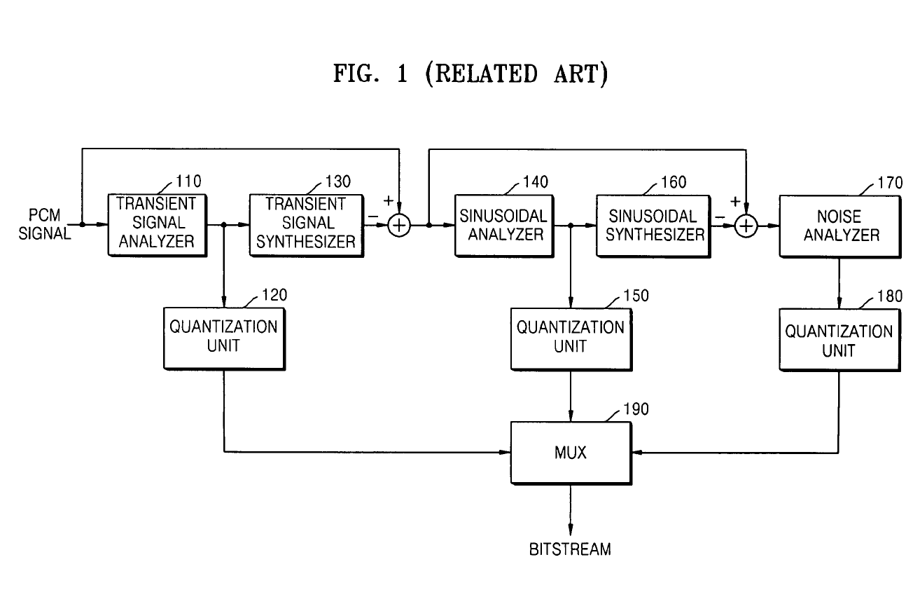

### DETAILED DESCRIPTION OF EXEMPLARY EMBODIMENTS OF THE INVENTION

The present invention will now be described more fully with reference to the accompanying drawings, in which exemplary embodiments of the invention are shown.

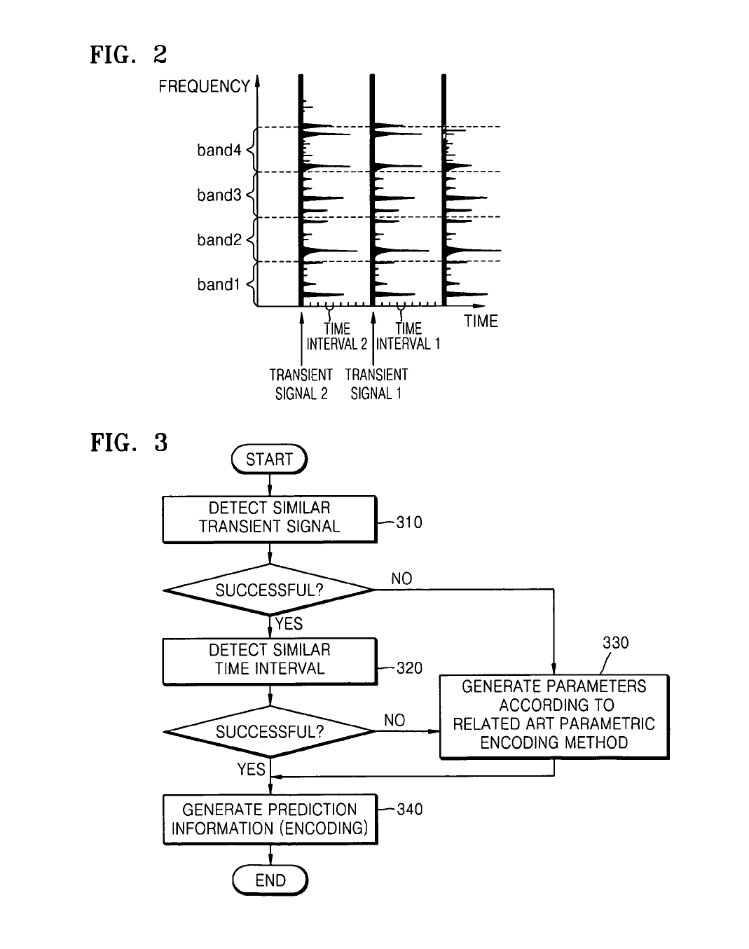

FIG. 2 is a graph showing waveforms of an audio signal to be encoded according to an exemplary embodiment of the present invention.

In the graph illustrated in FIG. 2, the x-axis is a time axis and the y-axis is a frequency axis. In a transient signal, as illustrated in the graph, most frequency components have high energy and component signals exist in some frequency bands in time intervals after a transient signal occurs. The component signals appearing in the time intervals after the transient signal occurs are the signals that are included in the immediate transient signal and do not disappear. Accordingly, it can be assumed that if the energies of transient signals are similar to each other, the component signals in the time intervals after the transient signals occur are also similar to one another. Based on this fact, the present invention suggests an encoding and decoding method for low bitrate.

For example, in FIG. 2, in order to encode parameters of component signals in time interval 1, an encoder does not generate a parameter of each of the component signals of the time interval 1, but detects a transient signal which is most similar to the latest transient signal, i.e., a transient signal 1, from among transient signals occurring before the transient signal 1. A variety of methods of detecting a similar transient signal may be used. By comparing energies of transient signals, transient signals having similar energies can be determined to be similar to each other.

If it is determined that the transient signal 1 and the transient signal 2 are similar to each other, a time interval of which component signals are similar to the component signals of the time interval 1 is detected from among time intervals between the occurrence time of the transient signal 1 and the occurrence time of the transient signal 2. If it is determined that a sinusoidal signal from among the component signals of the time interval 2 is similar to a sinusoidal signal of the time interval 1, the sinusoidal signal of the time interval 1 is encoded by using information on the time interval 2.

That is, the sinusoidal signal of the time interval 1 is encoded by using index information indicating the time interval 2, instead of parameters such as the amplitude, frequency, and phase.

When the sinusoidal signal of the time interval 1 is decoded, a decoder which decodes a parametric-encoded audio signal, which is encoded by using the method described above, will obtain index information on the time interval 2 instead of parameters of the sinusoidal signal itself of the time interval 1. Then, by referring to the information, the decoder detects parameters of the sinusoidal signal in the time interval 2, and by regarding the parameters as parameters indicating the sinusoidal signal of the time interval 1, the decoder restores the whole audio signal in the time interval 1.

Meanwhile, the encoding and decoding methods as described above can be performed in each frequency band. That is, a decoder according to an exemplary embodiment of the present invention can divide the audio signal into four frequency bands, as illustrated in FIG. 2, and perform detection of a transient signal and a time interval, and encoding.

For example, when a sinusoidal signal existing in band 1 in the time interval 1 is encoded, a transient signal most similar to the transient signal 1 is detected in the band 1.

If the transient signal 2 is detected, a time interval of which sinusoidal signal in the band 1 is most similar to the sinusoidal signal of the band 1 in the time interval 1 is detected.

If it is determined that the sinusoidal signal from among the component signals existing in the band 1 of the time interval 2 is similar to the sinusoidal signal existing in the band 1 of the time interval 1, the sinusoidal signal of the time interval 1 is encoded by using information on the time interval 2. That is, the sinusoidal signal existing in the band 1 of the time interval 1 is encoded by using index information indicating the band 1 of the time interval 2, instead of parameters such as the amplitude, frequency, and phase.

When the sinusoidal signal existing in the band 1 of the time interval 1 is decoded, a decoder which decodes a parametric-encoded audio signal, which is encoded by using the method described above, will obtain index information indicating the band 1 of the time interval 2 instead of parameters of the sinusoidal signal itself existing in the band 1 of the time interval 1. Then, by referring to the information, the decoder detects parameters of the sinusoidal signal existing in the band 1 of the time interval 2, and by regarding the parameters as parameters of the sinusoidal signal existing in the band 1 of the time interval 1, the decoder restores the audio signal in the time interval 1.

FIG. 3 is a flowchart illustrating a method of encoding an audio signal according to an exemplary embodiment of the present invention.

In operation 310, a transient signal (hereinafter, a similar transient signal) most similar to a recently occurred transient signal relative to a time interval currently desired to be encoded (hereinafter, an encoding target time interval) is detected from among previous transient signals. As described above, detection of the similar transient signal can be performed in each frequency band, and in this case, a plurality of similar transient signals will be detected in each frequency band.

If a similar transient signal is not detected, the component signals of the encoding target time interval are encoded according to related art parametric encoding method and parameters are generated in operation 330.

If a similar transient signal is detected, a time interval of which a component signal is similar to a component signal of the encoding target time interval is detected from among time intervals after the detected similar transient signal, in operation 320. In other words, a time interval (hereinafter, a similar time interval) of which a component signal is similar to at least one of the component signals of the encoding target time interval is detected. If detection of a transient signal is performed in a predetermined frequency band in operation 310, detection of a time interval is also performed in the predetermined frequency band. A similar time interval may be detected from among time intervals between the occurrence time of a similar transient signal and the occurrence time of a transient signal which first occurs after the similar transient signal.

If a similar time interval is not detected, all or part of the component signals of the encoding target time interval are encoded according to the related art parametric encoding method, thereby generating parameters in operation 330.

In operation 340, by generating index information (hereinafter will be referred to as prediction information) on the similar time interval according to whether or not detection is successful in operation 320, all or part of the component signals of the encoding target time interval are encoded. In other words, the prediction information is used as parameters for the component signals. When operations 310 and 320 are performed in each frequency band, component signals are necessarily encoded separately in each frequency band in operation 340. For example, a sinusoidal signal existing in a band X of an encoding target time interval K is encoded by using prediction information indicating a sinusoidal signal existing in the band X of a similar time interval A, and a sinusoidal signal existing in a band Y of the same encoding target time interval K can be encoded by using prediction information indicating a sinusoidal signal existing in the band Y of another time interval B.

Meanwhile, noise existing in the band X of the encoding target time interval K may be dissimilar to noise existing in the band X of the similar time interval A, but similar to noise existing in the band X of a time interval C. In this case, the time interval C is a similar time interval in relation to noise, and the noise existing in the band X of the time interval K is encoded by using prediction information which is index information allowing parameters of the noise existing in the band X of the similar time interval C.

If all or part of component signals cannot be encoded by using prediction information, the component signals are encoded according to the related art parametric encoding method.

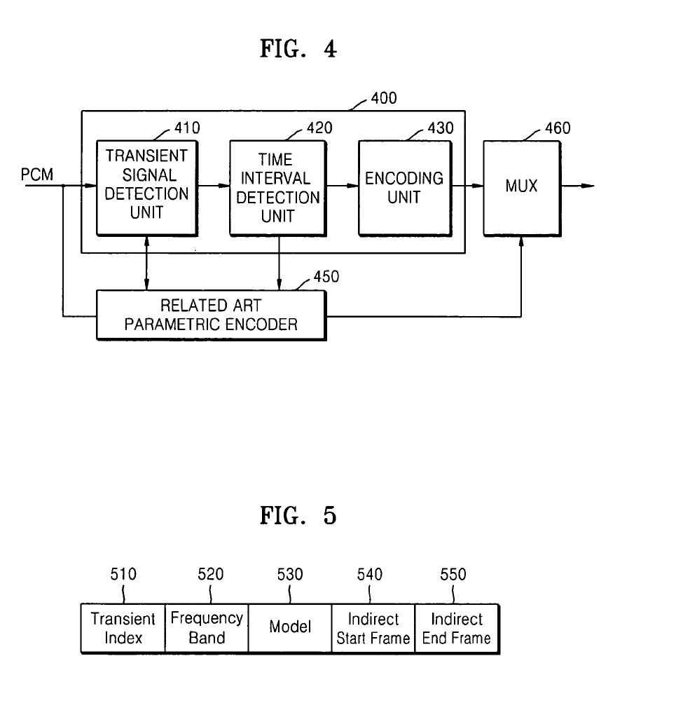

FIG. 4 is a diagram illustrating a structure of an apparatus 400 for encoding an audio signal according to an exemplary embodiment of the present invention. As illustrated in FIG. 4, the encoding apparatus 400 according to an exemplary embodiment includes a transient signal detection unit 410, a time interval detection unit 420, and an encoding unit 430.

If a PCM signal is input, a transient signal is encoded by a related art parametric encoder 450. The transient signal detection unit 410 first searches transient signals occurring before an encoding target time interval for a most recently occurring transient signal A, and detects similar transient signals among transient signals occurring before the transient signal A. In this case, the transient signal detection unit 410 may detect similar transient signals in each frequency band. For example, it can be determined that a band 1 of the transient signal A is similar to that of a transient signal C, and a band 2 of transient signal A is similar to that of a transient signal D. In such case, a plurality of similar transient signals are detected.

If a similar transient signal does not exist in relation to all or part of frequency bands, the component signals of the all or part of the frequency bands of the encoding target time interval are encoded by the related art parametric encoder 450.

If a similar transient signal exists, the time interval detection unit 420 detects a similar time interval in relation to each component signal. In the above example, a similar time interval may be detected among time intervals between the transient signal A and a transient signal which first occurs after the transient signal A. When the transient signal detection unit 410 detects a similar transient signal in each frequency band, the time interval detection unit 420 also detects a similar time interval in each frequency band. If a similar time interval in relation to all or part of component signals in all or part of frequency bands does not exist, the all or part of the component signals in relation to the all or part of the frequency bands of the time interval X are encoded by the related art parametric encoder 450.

If a similar time interval exists, the encoding unit 430 encodes all or part of the component signals of the time interval X by using prediction information of the similar time interval. The prediction information will be explained in more detail later with reference to FIG. 5.

When the encoding is completed, the encoded data is generated as a bitstream by a multiplexer 460.

FIG. 5 is a diagram illustrating a structure of prediction information used in a method of encoding and decoding an audio signal according to an exemplary embodiment of the present invention. As illustrated in FIG. 5, the prediction information includes a transient signal index 510, frequency band information 520, information 530 indicating the type of a component signal, similar time interval start information 540 and similar time interval end information 550.

The transient signal index 510, the similar time interval start information 540, and the similar time interval end information 550 are information ultimately indicating the position of a similar time interval. The similar time interval start information 540 and the similar time interval end information 550 indicate relative distances between the start point and end point, respectively, of a similar time interval and a transient signal determined by the transient signal index 510.

The frequency band information 520 indicates a frequency band in which prediction information is valid.

The information 530 indicating the type of a component signal indicates the type of component signals of the encoding target time interval and the similar time interval which are similar to each other. It can be clearly understood by a person skilled in the art that the type of a component signal can vary with respect to a method of modeling an audio signal. For example, a sinusoidal signal or a noise signal can be a component signal.

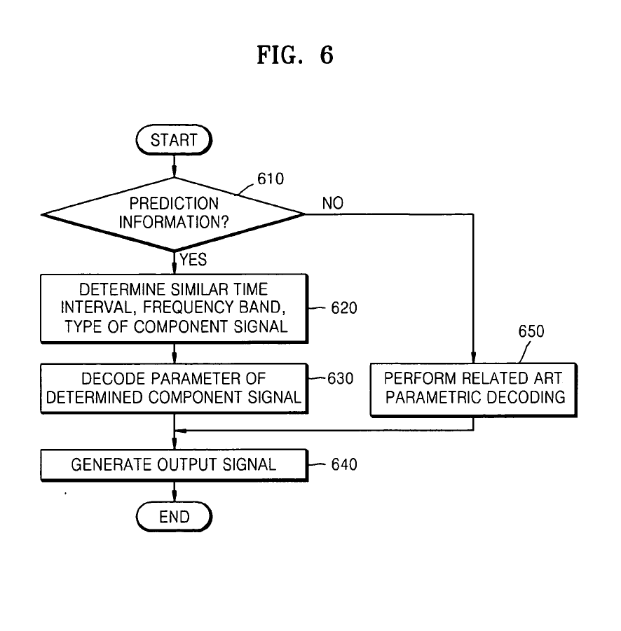

FIG. 6 is a flowchart illustrating a method of decoding an audio signal according to an exemplary embodiment of the present invention.

In operation 610, it is determined whether information indicated by an input bitstream is a parameter generated by the related art parametric encoding method or prediction information generated according to the present invention. This can be performed by referring to the header of a file. If it is determined that the information is not the prediction information generated according to the present invention, the information is decoded according to the related art decoding method. If the information is the prediction information according to the present invention, operation 620 is performed.

In operation 620, by referring to the prediction information, similar time intervals, frequency bands, and the types of component signals are determined.

In operation 630, parameters of component signals in the similar time intervals and frequency bands are decoded.

In operation 640, the signal obtained by the decoding is regarded as the component signal of a decoding target time interval, and a whole output signal in the decoding target time interval, i.e., an audio signal in the time domain, is generated.

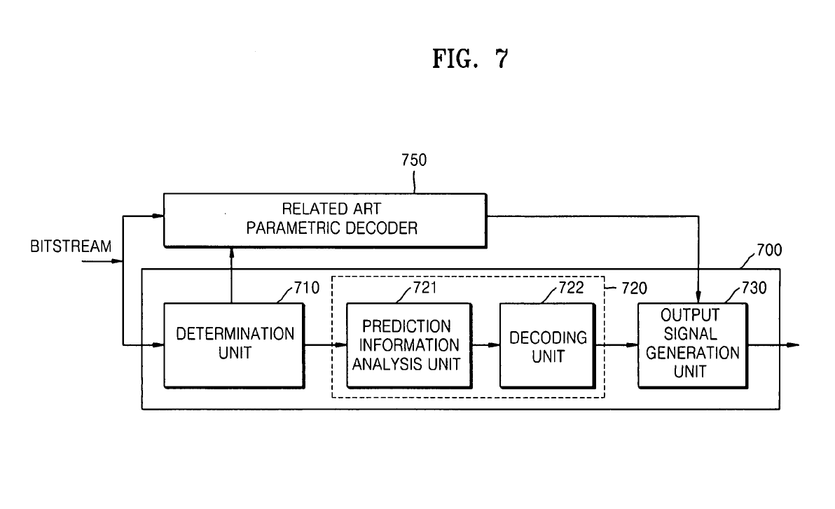

FIG. 7 is a diagram illustrating a structure of an apparatus 700 for decoding an audio signal according to an exemplary embodiment of the present invention.

As illustrated in FIG. 7, the decoding apparatus 700 according to an exemplary embodiment includes a determination unit 710, a restoration unit 720, and an output signal generation unit 730.

The determination unit 710 determines whether or not parameters for the component signals of a decoding target time interval in an input bitstream are prediction information according to the present invention. If the determination result by the determination unit 710 indicates that the parameters are not the prediction information, decoding is performed by a related art parametric decoder 750.

Though the related art parametric decoder 750 is implemented separately from the decoding apparatus 700 according to the exemplary embodiment in FIG. 7, the related art parametric decoder 750 may also be implemented as an internal module of the decoding apparatus 700.

If the determination result by the determination unit 710 indicates that the parameters of the component signals of the decoding target time interval is the prediction information according to the present invention, decoding is performed according to an algorithm of the present invention. The restoration unit 720 includes a prediction information analysis unit 721, and a decoding unit 722.

The prediction information analysis unit 721 analyzes the prediction information, and determines the positions of similar time intervals, the types of component signals, and frequency bands. According to the determination of the prediction information analysis unit 721, the decoding unit 722 decodes the component signals of the decoding target time interval by using parameters of all or part of component signals of all or part of frequency bands of similar time intervals.

The output signal generation unit 730 regards the signal obtained as the result of the decoding by the decoding unit 722, i.e., the component signals of the similar time intervals, as the component signal of the decoding target time interval, and generates a whole output signal in the decoding target time interval, i.e., an audio signal in the time domain.

According to the present invention, not all parameters for all component signals are generated in a parametric encoder, and according to a time interval, index information allowing similar previous time intervals to be found is used as parameters for some component signals, thereby increasing encoding efficiency.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A parametric encoding method comprising:
detecting a second transient signal similar to a first transient signal from among a plurality of transient signals occurring before the first transient signal;
detecting a second time interval in which a second component signal similar to a first component signal of a first time interval after the occurrence of the first transient signal exists, from among a plurality of time intervals after the occurrence of the second transient signal; and
encoding the first component signal of the first time interval by using information on the second time interval.

2. The method of claim 1, wherein the information on the second time interval comprises at least one of information indicating a position of the second time interval, information indicating a frequency band in which the second component signal exists, from among a plurality of frequency bands of the second time interval, and information indicating a type of the second component signal.

3. The method of claim 2, wherein the information indicating the position of the second time interval comprises information indicating an index distinguishing a transient signal occurring at a start of the second time interval from other transient signals, and information indicating a position relative to the transient signal occurring at the start of the second time interval.

4. The method of claim 1, wherein in the encoding of the first component signal of the first time interval, the information on the second time interval is used as a parameter for the first component signal in the first time interval.

5. The method of claim 1, wherein the detecting of the second transient signal is performed by comparing energies of the plurality of transient signals occurring before the first transient signal with an energy of the first transient signal.

6. The method of claim 1, wherein in the detecting of the second transient signal, transient signals similar to the first transient signal are detected in each frequency band of a plurality of frequency bands, and
in the detecting of the second time interval, at least one time interval is detected in at least one frequency band of the plurality of frequency bands in which at least one transient signal similar to the first transient signal is detected, and
in the encoding of the first component signal, the first component signal in the first time interval is encoded in each frequency band of the plurality of frequency bands by using the information on the at least one detected time interval.

7. The method of claim 1, wherein the first component signal comprises at least one of a sinusoidal signal and noise.

8. A computer readable recording medium having embodied thereon a computer program for executing a parametric encoding method comprising:
detecting a second transient signal similar to a first transient signal from among a plurality of transient signals occurring before the first transient signal;
detecting a second time interval in which a second component signal similar to a first component signal of a first time interval after the occurrence of the first transient signal exists, from among a plurality of time intervals after the occurrence of the second transient signal; and
encoding the first component signal of the first time interval by using information on the second time interval.

9. A parametric encoding apparatus comprising:
a transient signal detection unit that detects a second transient signal similar to a first transient signal from among a plurality of transient signals occurring before the first transient signal;
a time interval detection unit that detects a second time interval in which a second component signal similar to a first component signal of a first time interval after the occurrence of the first transient signal exists, from among a plurality of time intervals after the occurrence of the second transient signal; and
an encoding unit that encodes the first component signal of the first time interval by using information on the second time interval.

10. The apparatus of claim 9, wherein the information on the second time interval comprises at least one of information indicating a position of the second time interval, information indicating a frequency band in which the second component signal exists, from among a plurality of frequency bands of the second time interval, and information indicating a type of the second component signal.

11. The apparatus of claim 9, wherein the information indicating a position of the second time interval includes information indicating an index distinguishing a transient signal occurring at a start of the second time interval from other transient signals, and information indicating a position relative to the transient signal occurring at the start of the second time interval.

12. The apparatus of claim 9, wherein the encoding unit uses the information on the second time interval as a parameter for the first component signal in the first time interval.

13. The apparatus of claim 9, wherein the transient signal detection unit detects the second transient signal by comparing the energies of the plurality of transient signals occurring before the first transient signal with the energy of the first transient signal.

14. The apparatus of claim 9, wherein the transient signal detection unit detects transient signals similar to the first transient signal in each frequency band of a plurality of frequency bands,
the time interval detection unit detects at least one timer interval in at least one frequency band of the plurality of frequency bands in which at least one transient signal that is similar to the first transient signal, and
the encoding unit encodes the first component signal in the first time interval in each frequency band of the plurality of frequency bands by using the information on the at least one detected time interval.

15. The apparatus of claim 9, wherein the component signal comprises at least one of a sinusoidal signal and noise.

16. A parametric decoding method comprising:
determining whether a parameter for a first component signal of a first time interval to be decoded is prediction information that has a format indicating at least one time interval; and
restoring the first component signal of the first time interval to be decoded, by selectively using the parameter for at least a second time interval of a plurality of time intervals occurring before the first time interval to be decoded, according to a result of the determining.

17. The method of claim 16, wherein if the result of the determining indicates that the parameter indicating the first component signal of the first time interval to be decoded is the prediction information, the restoring of the first component signal comprises:
by referring to the prediction information, determining a position of the second time interval, a frequency band in which the parameter exists from among a plurality of frequency bands of the second time interval, and a type of the first component signal to be decoded based on the parameter;
decoding the parameter for the first component signal of the determined type in the determined frequency band in the determined second time interval; and
regarding a signal obtained by the decoding as the first component signal of the determined type in the determined frequency band in the first time interval to be decoded, and generating a whole output signal in the first time interval to be decoded.

18. The method of claim 17, wherein the prediction information comprises at least one of information indicating a frequency band in which a second component signal is similar to a first component signal in the first time interval to be decoded, from among a plurality of frequency bands of the second time interval, information indicating a type of the second component signal, and information indicating a position of the second time interval.

19. The method of claim 18, wherein the information indicating the position of the second time interval comprises information indicating an index distinguishing a transient signal occurring at a start of the second time interval from other transient signals, and a position relative to the transient signal occurring at the start of the second time interval.

20. The method of claim 16, wherein the component signal comprises at least one of a sinusoidal signal and noise.

21. A computer readable recording medium having embodied thereon a computer program for executing a parametric decoding method comprising:
determining whether a parameter for a first component signal of a first time interval to be decoded is prediction information that has a format indicating at least one time interval; and
restoring the first component signal of the first time interval to be decoded, by selectively using the parameter for at least a second time interval of a plurality of time intervals occurring before the first time interval to be decoded, according to a result of the determining.

22. A parametric decoding apparatus comprising:
a determination unit that determines whether a parameter for a first component signal of a first time interval to be decoded is prediction information that has a format indicating at least one time interval; and
a restoration unit that restores the first component signal of the first time interval to be decoded, by selectively using the parameter for at least a second time interval of a plurality of time intervals occurring before the first time interval to be decoded, according to a result of the determination.

23. The apparatus of claim 22, wherein the restoration unit comprises:
a prediction information analysis unit that, if the result of the determining indicates that the parameter indicating the first component signal of the first time interval to be decoded is the prediction information, determines, by referring to the prediction information, a position of the second time interval, a frequency band in which the parameter exists from among a plurality of frequency bands of the second time interval, and a type of the first component signal to be decoded based on the parameter;
a decoding unit that decodes the parameter for the first component signal of the determined type in the determined frequency band in the determined second time interval; and
an output signal generation unit that regards a signal obtained by the decoding as the first component signal of the determined type in the determined frequency band in the first time interval to be decoded, and that generates a whole output signal in the first time interval to be decoded.

24. The apparatus of claim 22, wherein the prediction information comprises at least one of information indicating a frequency band in which a second component signal is similar to a first component signal in the first time interval to be decoded, from among a plurality of frequency bands of the second time interval, information indicating a type of the second component signal, and information indicating a position of the second time interval.

25. The apparatus of claim 24, wherein the information indicating the position of the second time interval comprises information indicating an index distinguishing a transient signal occurring at a start of the second time interval from other transient signals, and a position relative to the transient signal occurring at the start of the second time interval.

26. The apparatus of claim 22, wherein the component signal comprises at least one of a sinusoidal signal and noise.
